(19) United States
(12) Patent Application Publication
(10) Pub. No.: US 2026/0106685 A1
(43) Pub. Date: Apr. 16, 2026

(54) POLARIZATION SENSITIVE SIGNAL ROUTER

(71) Applicant: AT&T Intellectual Property I, L.P., Atlanta, GA (US)

(72) Inventors: Ricky A. Perry, Cumming, GA (US); Stewart Edward Barker, Lucas, TX (US); Lujing Cai, Morganville, NJ (US)

(73) Assignee: AT&T Intellectual Property I, L.P., Atlanta, GA (US)

(21) Appl. No.: 18/914,605

(22) Filed: Oct. 14, 2024

(51) Int. Cl. H04J 14/02; H04B 10/532

(52) U.S. Cl. CPC H04J 14/0221; H04B 10/532

(57) ABSTRACT

Aspects of the subject disclosure may include, for example, an optical signal distribution device including an optical amplifier and an optical power divider. The optical amplifier may be configured to apply an optical signal gain that amplifies a downstream optical signal operating at a first optical power level to a second, increased optical power level. The optical power divider includes a first optical port and a group of second optical ports, in which the first optical port is optically coupled to the optical amplifier. The optical power divider is configured to apply a power division process to the amplified downstream signal to obtain a group of divided optical signals that may be provided to the group of second optical ports. The resulting optical signal levels of the group of divided optical signals are reduced from the second, increased optical power level according to the power division. Other embodiments are disclosed.

### FIELD OF THE DISCLOSURE

The subject disclosure relates to a polarization sensitive signal router.

### BACKGROUND

In an optical network, a signal may be transmitted over an optical fiber. The signal may include more than one channel. A power splitter may divide a channel into a group of distinct outputs. A signal, containing a single channel or multiple channels, may be divided by a splitter, with the divided signal portions delivered to several different destinations.

Currently, there is particular demand for optical splitter devices for use in fiber-to-the-curb (FTTC) and fiber-to-the-home (FTIB) communication networks. These splitter devices facilitate the distribution of a common signal to multiple customers.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2 is a block diagram illustrating an example, non-limiting embodiment of a polarization-sensitive optical access network functioning within the communication network of FIG. 1 in accordance with various aspects described herein.

FIG. 3 is a block diagram illustrating an example, non-limiting embodiment of another polarization-sensitive optical access network functioning within the communication network of FIG. 1 in accordance with various aspects described herein.

FIG. 4 is a block diagram illustrating an example, non-limiting embodiment of yet another polarization-sensitive optical access network functioning within the communication network of FIG. 1 in accordance with various aspects described herein.

FIG. 5A is a block diagram illustrating an example, non-limiting embodiment of an optical terminal functioning within the communication network of FIG. 1 in accordance with various aspects described herein.

FIG. 5B is a block diagram illustrating an example, non-limiting embodiment of another optical terminal functioning within the communication network of FIG. 1 in accordance with various aspects described herein.

FIG. 6 depicts an illustrative embodiment of a polarization-sensitive optical signal distribution process in accordance with various aspects described herein.

FIG. 7 depicts an illustrative embodiment of another polarization-sensitive optical signal distribution process in accordance with various aspects described herein.

FIG. 8 is a block diagram of an example, non-limiting embodiment of a computing environment in accordance with various aspects described herein.

### DETAILED DESCRIPTION

The subject disclosure describes, among other things, illustrative embodiments for routing signals in a passive optical network according to the signals' polarization.

One or more aspects of the subject disclosure include an optical signal distribution device. The optical signal distribution device includes a housing that includes a source port configured to receive an optical signal. The optical signal includes a first optical signal component associated with a first polarization and a second optical signal component associated with a second polarization. The housing further includes a group of destination ports and a first optical signal divider. The first optical signal divider includes an undivided signal terminal optically coupled to the source port and a group of divided signal terminals. The first optical signal divider is configured to divide the optical signal to obtain a group of divided signals presented at the group of divided signal terminals. The housing further includes a first polarization discriminator optically coupled between a first one of the group of divided signal terminals and a at least one of a first group of destination ports of the group of destination ports. The first polarization discriminator is configured to isolate the first optical signal component associated with the first polarization to obtain an isolated first optical signal component.

One or more aspects of the subject disclosure include an optical signal distribution process that includes receiving an optical signal having a first optical signal component associated with a first polarization and a second optical signal component associated with a second polarization. The optical signal is divided to obtain a group of divided signals, and a first polarization filter is applied to a first one of the group of divided signals to obtain an isolated first optical signal component. The isolated first optical signal component is divided to obtain a first group of divided, isolated first optical signal components, and the first group of divided, isolated first optical signal components is associated with a first group of ports to obtain a first association. The divided, isolated first optical signal components are distributed according to the first polarization and based on the first association.

One or more aspects of the subject disclosure include a non-transitory, machine-readable medium, that includes executable instructions that, when executed by a processing system including a processor, facilitate performance of operations. The operations include determining a first service associated with a first group of remote terminals optically coupled to a first group of router ports adapted for a first polarization. The operations further include determining a second service associated with a second group of remote terminals coupled to a second group of router ports adapted for a second polarization. The first service is associated with the first polarization, wherein first service messages are routed to the first group of remote terminals according to the first polarization. The second service is associated with the second polarization, wherein second service messages are routed to the second group of remote terminals according to the second polarization.

A conventional optical signal splitter introduces an insertion loss according to a power division of an input optical signal. The illustrative devices, systems, processes and computer readable media disclosed herein provide polarization-sensitive signal distribution that can incorporate one or more optical splitters, optical combiners and/or optical splitter/combiner combinations. In at least some embodiments, an optical signal distribution device is configured to distribution optical signals according to polarization. It is envisioned that in at least some embodiments, the polarization-sensitive optical splitting, combining and/or splitting/combining devices may be operable in a passive manner, e.g., without requiring power other than the optical signals processed by the splitter, combiner and/or splitter/combiner devices. In at least some embodiments, one or more polarization devices, e.g., polarizers and/or polarization devices may be combined with and/or integrated into one or more optical signal splitters, optical signal combiners and/or optical splitter/combiner combinations. Accordingly, optical signals may be selectively divided, combined, routed and/or otherwise distributed according to a polarization sense of optical signals, including information bearing signals, processed by the polarization-sensitive signal distribution devices. At least some of the examples disclosed herein provide passive polarization-sensitive signal processing devices that that are particularly well suited for passive optical network (PON) architectures.

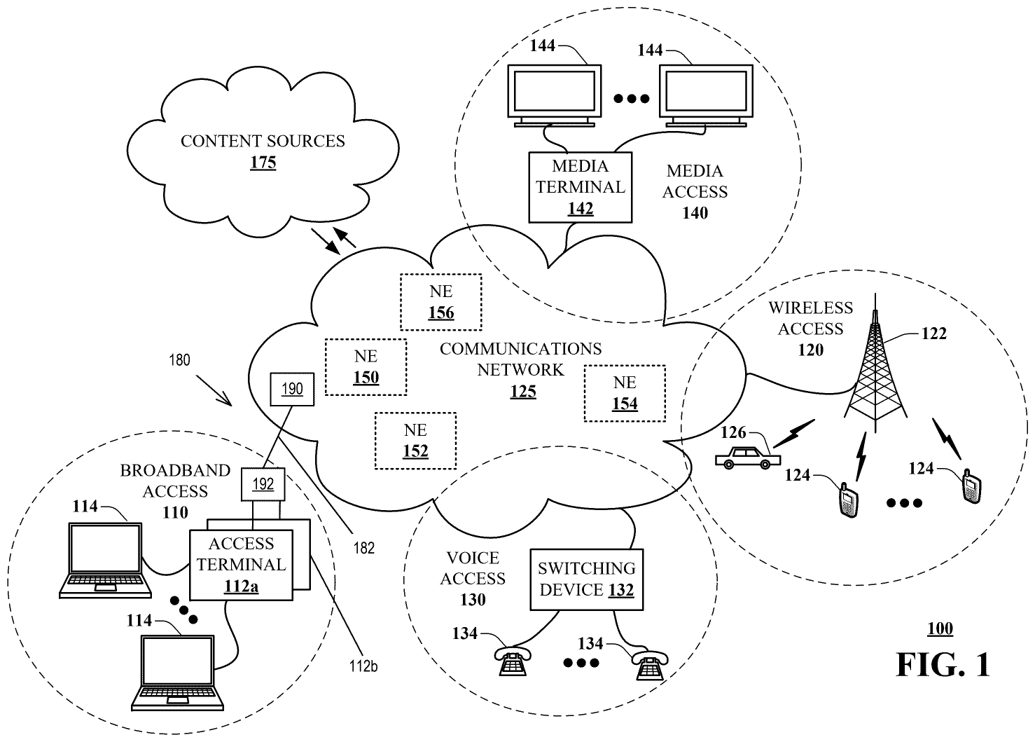

Referring now to FIG. 1, a block diagram is shown illustrating an example, non-limiting embodiment of a communication network 100 in accordance with various aspects described herein. For example, the communication network 100 can facilitate in whole or in part delivery of network services, such as broadband Internet access to the home and/or business via optical fiber distribution networks. In at least some configurations, these networks include passive optical networks (PONs) that provide an efficient means for signal transport and distribution. For example, a PON may be provided between a single network provider device, e.g., at an optical line terminal (OLT) at a headend of a network or at some other convenient network distribution node, and multiple end-user devices, such as optical network terminals (ONTs) at subscriber premises. It is common for such PON distribution networks to include optical power splitters, combiners and/or splitter/combiner combinations to manage optical signal distribution to ensure reliable network services.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets, or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway, or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

The example communication network 100 includes an optical network 180 extending network access and/or network accessible services to multiple access locations. For example, the optical network provides an optical communication channel, e.g., an optical fiber 182 between an upstream device, e.g., an optical line terminal (OLT) 190 and a group of access terminals 112a, 112b, generally 112. In more detail, the optical network 180 includes a polarization-sensitive optical signal distribution system 192 coupled between the ONT and the access terminals 112, e.g., optical network terminals (ONT). The polarization-sensitive optical signal distribution system 192 may be configured to selectively distribute, e.g., route, a downstream signal directed from the OLT 190 to the ONT 112, to divide and distribute the amplified downstream signal as may be required according to a particular number of ONT 112. In at least some embodiments, the polarization-sensitive optical signal distribution system 192 facilitates coexistence of multiple optical signals on the same optical fiber 182. Without limitation, the multiple optical signals may include different optical signals having different polarizations. The different optical signals may be distinguishable according to the different polarizations. It is further understood that the optical network 180 may operate in a downstream direction, an upstream direction, e.g., from the ONT 112 to the OLT 190 and/or a combination of upstream and downstream directions.

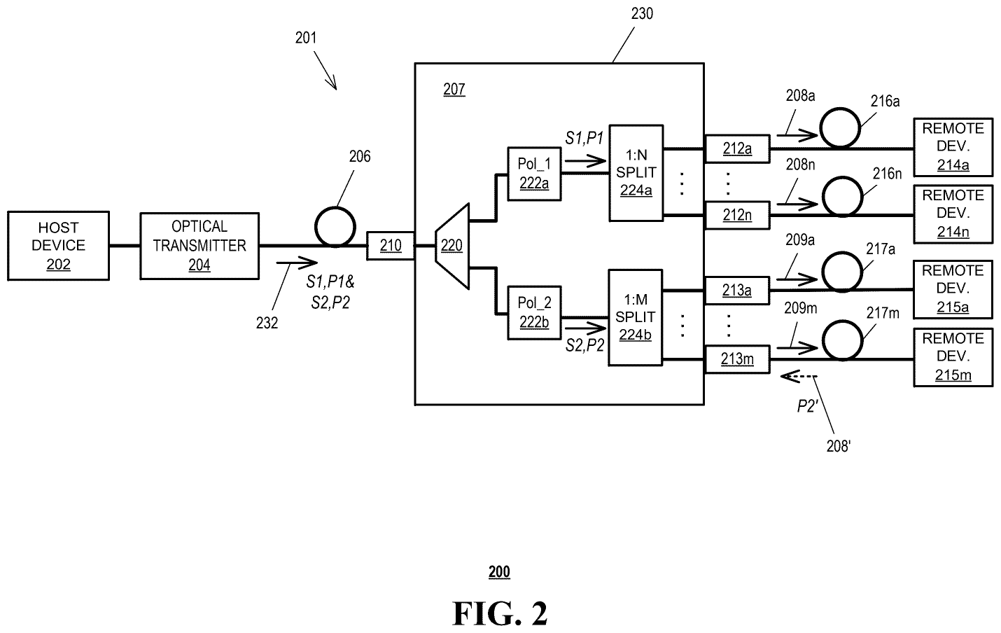

FIG. 2 is a block diagram illustrating an example, non-limiting embodiment of polarization-sensitive optical access network 200 functioning within the communication network 100 of FIG. 1 in accordance with various aspects described herein. The example polarization-sensitive optical access network 200 exchanges one or more optical signals over an optical fiber network 201. Without limitation, the optical fiber network 201 may include a passive optical network (PON), such as Ethernet passive optical network (EPON), Gigabit Passive Optical Network (GPON), Broadband Passive Optical Network (BPON), all types of fiber optic infrastructure, such as the home (FTTH), the premises (FTTP), the curb (FTTC), or the node (FTTN), sometimes referred to as FTTX, and the like. The optical signal(s), in turn, may include one or more channels, e.g., distinguishable by one or more of time, frequency, wavelength, phase and/or encoding. To this end, the example polarization-sensitive optical access network 200 includes at least one optical signal distribution device 207 configured to divide and/or otherwise split at least one downstream optical signal 232 into multiple optical output signals. For example, the optical signal distribution device 207 splits and/or otherwise divides a downstream optical signal 232 into multiple downstream optical signals 208a . . . 208n and 209a . . . 209m, generally 208, 209.

According to the illustrative embodiment, the downstream optical signal 232 includes multiple signal components that may be distinguishable from each other according to respective signal qualities, e.g., polarizations. For example, the downstream optical signal 232 may have a first signal component S1 configured according to a first polarization P1 and a second signal component S2 configured according to a second polarization P2. Without limitation, the polarizations P1, P2 may include any combination of linear polarizations, circular polarizations and/or elliptical polarizations. In at least some embodiments, the different polarizations P1, P2 may be orthogonal polarizations. It is understood that providing signal components S1, S2 with distinguishable polarizations may facilitate a selective processing of the downstream optical signal 232. For example, in at least some embodiments, the different signal components S1, S2 may be distributed, routed and/or otherwise directed differently according to their respective polarizations P1, P2.

By way of example, the polarization-sensitive optical access network 200 includes at least one host device 202 coupled to at least one optical transmitter 204. In at least some embodiments, the polarization-sensitive optical access network 200 includes an optical line terminal (OLT), configured to generate and/or otherwise provide, e.g., injection the downstream optical signal 232 into the optical fiber network 201. In at least some embodiments, the OLT may include one or more of the host device 202 and/or the optical transmitter 204. In at least some embodiments, the OLT, e.g., the host device 202 and/or the optical transmitter 204, may include one or more a central processing unit (CPU), passive optical network cards, a gateway router and a voice gateway uplink cards. The OLT, e.g., the host device and/or the optical transmitter 204 may be configured to modulate an optical carrier signal having characteristics well suited for broadband signal distribution over an extended distance and to a substantial number of remote devices, e.g., optical network terminals (ONT).

The optical signal distribution device 207 divides the downstream optical signal 232 into the multiple downstream optical output signals 208, 209 that may be delivered to one or more different destinations. According to the illustrative example, the different destinations include a first group of remote devices 214a . . . 214n, generally 214, and a second group of remote devices 215a . . . 215m, generally, 215. In at least some embodiments, the remote devices 214, 215 may include optical network terminals (ONTs), as may be employed in fiber-to-the-curb (FTTC) and/or fiber-to-the-home (FTTH) applications. In at least some embodiments, the optical signal distribution device 207 facilitates distribution of a common signal, e.g., the downstream optical signal 232, to multiple customers, e.g., via the remote devices 214, 215, which may be located at customer premises.

In at least one embodiment, the optical transmitter 204 transmits the downstream optical signal 232 via the optical fiber network 201 to provide subscriber information to the end-users or subscribers, such as content and/or network services. It is understood that according to such applications the optical transmitter 204 may be configured to transmit a common optical channel, one or more independent optical channels and/or any combination thereof, e.g., to each subscriber and/or differentiated groups of subscribers via on-premises equipment, such as the example remote devices 214, 215. In this manner, the optical transmitter 204 may provide subscribers with any combination of broadcast, multicast, and/or dynamically allocated voice, data, and/or video bandwidth.

In at least some applications, it may be advantageous to distinguish the remote devices 214, 215, e.g., into the example first group of remote devices 214 and the example second group of remote devices 215. The different groups of remote devices 214, 215 may be distinguished according to one or more of a remote device capability, a level of service as may be determined according to a level of service subscription, a service level agreement, and/or an application requirement. Applications may include, without limitation, voice, streaming media, gaming, virtual reality, home automation, security, robotics, autonomous vehicles, such as cars and/or drones, machine-to-machine (M2M) communications, Internet of Things (IoT), email, messaging, web browsing and so on. For example, the first group of remote devices may include devices capable of high-fidelity streaming media, while the second group of remote devices may include less demanding, home automation systems. Alternatively, or in addition, the different groups of remote devices 214, 215 may be distinguished according to historical records, e.g., based on prior usage as may be evaluated according to one or more of data volumes, data types, data rates, applications, application categories, and the like. Alternatively, or in addition, at least some embodiments, the different groups of remote devices may be distinguished according to anticipated and/or predicted applications, data volumes, data types, data rates, and so on. It is envisioned that in at least some applications, the different groups of remote devices 214, 215 may be distinguished according to network performance as may be determined according to past performance, current network conditions and/or anticipated and/or predicted performance.

As may be beneficial, the host device 202 and/or the optical transmitter 204 may determine the first optical signal S1 and an association of the first optical signal with the first group of remote devices 214. For example, the first optical signal S1 may be based on one or more of a service, e.g., a subscribed network service, a class of network services, and/or third-party service, e.g., an over-the-top (OTT) service or class of OTT services, such as OTT media services. Alternatively, or in addition be associated with the first group of remote devices 214 may be determined according to one or more applications and/or categories of applications. In at least some embodiments, the host device 202 and/or the optical transmitter 204 may identify the first group of remote devices 214 and associate the first optical signal S1 with the first group of remote devices 215. Likewise, the host device 202 and/or the optical transmitter 204 may determine the second optical signal S2 and an association of the second optical signal with the second group of remote devices 215, such that the first and second signals S1, S2 may support network services according to respective requirements, which may be the same, similar and/or different.

In at least some embodiments, the optical signal distribution device 207 includes a housing 230. The housing 230 includes an upstream housing terminal or port 210 coupled to one end of an upstream optical fiber segment 206, e.g., a feeder fiber, which may be coupled between the optical signal distribution device 207 and the optical transmitter 204. In at least some embodiments, the optical signal distribution device 207 has multiple downstream terminals or downstream ports. According to the illustrative embodiment, the downstream ports arranged according to a first group of downstream ports 212a . . . 212n, generally 212, and a second group of downstream ports 213a . . . 213m, generally 213. The first group of downstream ports 212 are respectively coupled to first ends of a first group of downstream optical fiber segments 216a . . . 216n, generally 216. Likewise, the second group of downstream ports 213 are respectively coupled to first ends of a second group of downstream optical fiber segments 217a . . . 216m, generally 217. The first group of downstream optical fiber segments 216 have second ends that are respectively coupled to and/or otherwise in optical communication with the first group of remote devices 214, and the second group of downstream optical fiber segments 217 have second ends that are respectively coupled to and/or otherwise in optical communication with the second group of remote devices 215.

In at least some embodiments, the optical signal distribution device 207 includes at least one upstream optical signal splitter 220, one or more optical polarization devices, e.g., first and second optical polarization devices 222a, 222b, generally 222, and one or more downstream optical signal splitters, e.g., first and second downstream optical signal splitters 224a, 224b, generally 224. The upstream optical signal splitter 220 has an upstream terminal coupled to the upstream port 210, a first downstream terminal coupled to an upstream side of the first polarization device 222a and a second downstream terminal coupled to an upstream side of the second polarization device 222b. The first polarization device 224a has a downstream terminal coupled to an upstream terminal of the first optical signal splitter 224a. Likewise, the second polarization device 224b has a downstream terminal coupled to an upstream terminal of the second optical signal splitter 224b. According to the illustrative embodiment, the first optical signal splitter 224a performs a 1×N power division of a first signal presented at its upstream terminal and provides the divided signal portions among N output terminals. The N output terminals of the first optical signal splitter 224a are in communication with housing downstream ports 212a . . . 212n, generally 212. Similarly, the second optical signal splitter 224b performs a 1×M power division of a second signal presented at its upstream terminal and provides the divided signal portions among M output terminals. The M output terminals of the second optical signal splitter 224b are in communication with downstream housing ports 213a . . . 213m, generally 213.

In at least some embodiments, the first polarization device 222a configured to permit passage of the first optical signal S1 based on a first preferred polarization P1, while preventing passage of the second optical signal S2 based on a second non-preferred polarization P2. To the extent that the polarizations are orthogonal, it is understood that passage of S1 and rejection of S2 may be substantially complete. Likewise, the second polarization device 222b configured to permit passage of the second1 optical signal S2 based on a second preferred polarization P2, while preventing passage of the first optical signal S1 based on a first non-preferred polarization P1. Once again, to the extent that the polarizations are orthogonal, it is understood that passage of S2 and rejection of S1 may be substantially complete.

According to downstream operation, a divided portion of the first signal S1, e.g., S1/N, may be directed to each of the first group of remote devices 214 in communication with the first group of downstream ports 212 via respective downstream optical fiber segments 216a . . . 216n, generally 216. Likewise, a divided portion of the second signal S2, e.g., S2/M, may be directed to each of the second group of remote devices 215 in communication with the second group of downstream ports 213 via respective downstream optical fiber segments 217a . . . 217m, generally 217.

In some embodiments, M=N, in other embodiments, M>N and in yet other embodiments, M<N. The values of M and N may be determined based on demand, e.g., numbers of the first and/or second groups of remote devices 214, 215 to be served. Alternatively, or in addition, the values of M and N may be determined based on other factors, such as power requirements, e.g., establishing maximum values of M and/or N based on a power budget allowance as may be determined according to power levels of S1 and/or S2. In at least some embodiments, the values of M and/or N may be determined based on the associations of the first and second optical signals S1, S2 with the first and second groups of remote devices 214, 215.

In at least some embodiments, one or more of the first and second splitters 224a, 224b may be configured according to a power division ratio, e.g., a ratio of 1×N, in which an input optical signal having an input power level Pᵢₙ may be equally divided into N separate optical output signals, each having an output optical signal power level Pₒᵤₜ determined according to the power division ratio, e.g., Pₒᵤₜ=Pᵢₙ/N. In at least some embodiments, one or more of the first and second splitters 224a, 224b may include gain compensation as described in U.S. patent application Ser. No. 18/781,409, entitled “Gain Compensated Optical Splitter,” filed on Jul. 23, 2024, and incorporated by reference herein in its entirety. For example, the optical signal distribution device may include one or more optical amplifiers (not shown) to apply gain to a respective optical input signal. For example, an optical amplifier may apply a gain value G to an optical input signal having a corresponding optical power level L1. Accordingly, an optical input power Pᵢₙ at the upstream terminal of an optical power splitter 224 may be determined according to the value Pᵢₙ=G·L1. According to the example power division ratio of 1×N, an optical output power level Pₒᵤₜ of each of the downstream optical output signals may be determined according to the expression

$${P}_{out} = \frac{{GP}_{i n}}{N} .$$

The examples discussed thus far refer to operation of the optical signal distribution device 207 in a downstream direction in which a downstream optical input signal 232, e.g., directed from the optical transmitter 204 to the remote devices 214, 215, is first split into first and second groups of downstream optical output signals based on a respective polarization. Alternatively, or in addition, the optical signal distribution device 207 may be operated in an upstream direction, in which return signals, e.g., from one or more of the remote devices 214, 215, are combined, then directed towards the host device 202. In such instances, the optical transmitter may be replaced by an optical receiver configured to receive an upstream optical signal and/or an optical transceiver configured to transmit the downstream optical signal and to receive the upstream optical signal. According to the upstream direction, one or more of the optical power splitters 224 may be referred to as an optical power combiner 224, or more generally as an optical splitter/combiner 224. For example, it is understood that in at least some embodiments, one or more subscribers may generate content and/or otherwise communicate with other remote entities, such as the network service provider, e.g., via on-premises equipment, such as the example remote devices 214, 215 generating optical signals directed towards the host device 202. Thus, it can be appreciated that the signal from a network services provider, e.g., from the optical transmitter 204 at a “head end,” may be transmitted over the optical fiber network 201 in a “downlink” or “downstream” direction to subscriber equipment and as needed, desired channels can be split off using one or more optical signal distribution devices 207 at locations where those signals are desired. Likewise, signals from the subscriber equipment, e.g., from one or more of the remote devices 214, 215, may be transmitted toward the host device 202 or head end over the optical fiber network 201 in an “uplink” or “upstream” direction. The same can be said for any of the various example embodiments disclosed herein, e.g., they may be operated in a downstream direction, in an upstream direction, or in a bidirectional mode in which both downstream and upstream signals are processed by the amplified power splitting devices.

According to the upstream configurations, optical input signals, e.g., an upstream optical input signal 208′ generated at the remote device 215m may have a first optical power level P2′. The upstream optical input signals 208′ from two or more of the remote devices 215 may be combined by the second optical splitter/combiner 224 operating in a reverse direction in which upstream optical signals received on any one or more of the second group of downstream ports 213 are combined according to a power combination process within the signal splitter/combiner 224 to obtain a second power combined optical signal presented at the downstream terminal of the second polarization device 222b. The second power combined optical signal may then be filtered to selectively pass a second polarization P2, while rejecting other polarizations to obtain a second upstream, polarized power combined optical signal. In at least some embodiments, may then be further combined with a first power combined optical signal presented at the downstream terminal of the first polarization device 222a. The first power combined optical signal may then be filtered to selectively pass a first polarization P1, while rejecting other polarizations to obtain a first upstream, polarized power combined optical signal. In at least some embodiments, the upstream power splitter combiner 220 combines the first and second polarized power combined optical signals into a combined polarized power combined optical signal, which may then be directed to the host device 202, e.g., via an optical receiver and/or receiver portion of an optical transceiver.

It is envisioned that in at least some embodiments the first polarization device 222a includes a downstream filter portion configured to selectively pass a first polarized portion P1 of a downstream signal S1, while blocking, absorbing and/or otherwise excluding other polarized portions of the downstream signal in which P≠P1. Alternatively, or in addition, in at least some embodiments, the first polarization device 222a includes an upstream filter portion configured to selectively pass a first polarized portion of an upstream signal, while blocking, absorbing and/or otherwise excluding other polarizations P≠P1. In at least some embodiments, the first polarization device 222a is a bidirectional device, e.g., selectively passing first polarized portions of signals in upstream directions, downstream directions, or both downstream and upstream directions. It is understood that in at least some embodiments, the second polarization device 222b may be configured similarly.

In at least some embodiments, at least some of the upstream and/or downstream optical power splitters 220, 224 may include at least one fused biconical taper (FBT) splitter. Alternatively, or in addition, the optical power splitter 220 may include at least one planar lightwave circuit (PLC) splitters. It is understood that FBT splitters use two or more fibers, in which the fibers' coating layers are removed and the fibers may be stretched at the same time under a heating zone to form a signal splitting region, e.g., a double cone structure. The resulting fused waveguide structure may allow for control of a resulting splitting ratio, e.g., via controlling one or more of a length of the fiber torsion angle and/or an applied stretch. The PLC splitter may be configured as a micro-optical element, e.g., using photolithographic techniques to form optical waveguide at a medium layer and/or semiconductor substrate to realize a power splitting, or branch distribution function. For example, in at least some embodiments, graded-index silica-glass waveguides may be used to fabricate PLC optical splitters, allowing a resulting splitting ratio to be adjusted during the design and fabrication phases.

In some embodiments, at least one of the polarization devices 222 include a polarization controller. The polarization controller can be operable to provide a selected polarization, which in at least some embodiments, may be changed based on a configuration of the polarization controller. A beam of light can be thought of as being composed of two orthogonal electrical vector field components that vary in amplitude and frequency. Polarized light occurs when these two components differ in phase or amplitude. Polarization of an optical or light wave signal may be accomplished using waveplates via phase changes in the two orthogonal states of polarization. This approach may be applied to free-space optical transmission and/or waveguide transmission, e.g., via an optical fiber. For example, the configuration may be adjustable according to manual adjustment as may be performed during installation, and/or reconfiguration of the optical signal distribution device 207. In at least some embodiments, the polarization controller can utilize stress-induced birefringence produced by wrapping a fiber around two or three spools to create independent wave plates that alter the polarization of light in a single mode fiber. The resulting polarizations can be configured to any state, e.g., polarization control over the full Poincaré sphere. At least one example of a polarization controller includes a fiber polarization controller available from Thorlabs Inc., Newton, NJ.

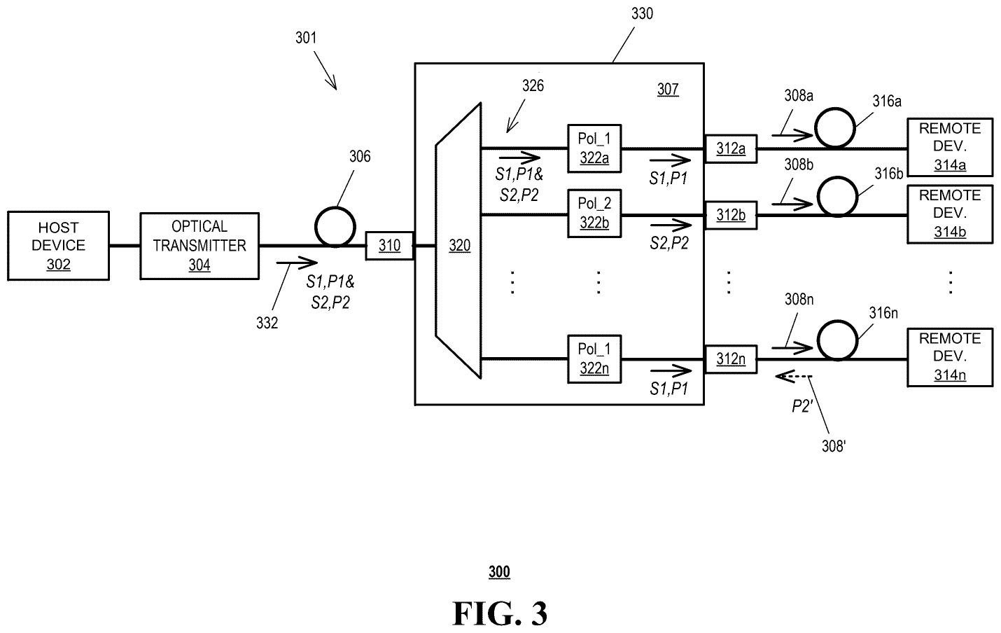

FIG. 3 is a block diagram illustrating another polarization-sensitive optical access network 300 functioning within the communication network 100 of FIG. 1 in accordance with various aspects described herein. The example polarization-sensitive optical access network 300 exchanges one or more optical signals over an optical fiber network 301. The example polarization-sensitive optical access network 300 also includes at least one optical signal distribution device 307 configured to divide and/or otherwise split at least one optical input signal 332 into multiple optical output signals. For example, the optical signal distribution device 307 splits and/or otherwise divides a downstream optical signal 332 into multiple downstream optical signals 308a . . . 308n.

According to the illustrative embodiment, the downstream optical signal 332 includes multiple signal components that may be distinguishable from each other according to respective signal qualities, e.g., polarizations. For example, the downstream optical signal 332 may have a first signal component S1 configured according to a first polarization P1 and a second signal component S2 configured according to a second polarization P2. Without limitation, the polarizations P1, P2 may include any combination of linear polarizations, circular polarizations and/or elliptical polarizations. In at least some embodiments, the different polarizations P1, P2 may be orthogonal polarizations. It is understood that providing signal components S1, S2 with distinguishable polarizations may facilitate a selective processing of the downstream optical signal 232. For example, in at least some embodiments, the different signal components S1, S2 may be distributed, routed and/or otherwise directed differently according to their respective polarizations P1, P2.

By way of example, the polarization-sensitive optical access network 300 includes at least one host device 302 coupled to at least one optical transmitter 304. In at least some embodiments, the polarization-sensitive optical access network 300 includes an optical line terminal (OLT), configured to generate and/or otherwise provide, e.g., injection the downstream optical signal 332 into the optical fiber network 301. In at least some embodiments, the OLT may include one or more of the host device 302 and/or the optical transmitter 304. In at least some embodiments, the OLT, e.g., the host device 302 and/or the optical transmitter 304, may include one or more a central processing unit (CPU), passive optical network cards, a gateway router and a voice gateway uplink cards. The OLT, e.g., the host device and/or the optical transmitter 304 may be configured to modulate an optical carrier signal having characteristics well suited for broadband signal distribution over an extended distance and to a substantial number of remote devices, e.g., optical network terminals (ONT).

The optical signal distribution device 307 divides the downstream optical signal 332 into the multiple downstream optical output signals 308, that may be delivered to one or more different destinations. According to the illustrative example, the different destinations include a group of remote devices 314a . . . 314n, generally 314. In at least some embodiments, the remote devices 314 may include optical network terminals (ONTs), as may be employed in fiber-to-the-curb (FTTC) and/or fiber-to-the-home (FTTH) applications. In at least some embodiments, the optical signal distribution device 307 facilitates distribution of a common signal, e.g., the downstream optical signal 332, to multiple customers, e.g., via the remote devices 314, which may be located at customer premises.

In at least one embodiment, the optical transmitter 304 transmits the downstream optical signal 332 via the optical fiber network 301 to provide subscriber information to the end-users or subscribers, such as content and/or network services. It is understood that according to such applications the optical transmitter 304 may be configured to transmit a common optical channel, one or more independent optical channels and/or any combination thereof, e.g., to each subscriber and/or differentiated groups of subscribers via on-premises equipment, such as the example remote devices 314. In this manner, the optical transmitter 204 may provide subscribers with any combination of broadcast, multicast, and/or dynamically allocated voice, data, and/or video bandwidth.

In at least some applications, it may be advantageous to distinguish the remote devices 314, e.g., into first and second types of remote devices 314. The different types of remote devices 314 may be distinguished according to one or more of a remote device capability, a level of service as may be determined according to a level of service subscription, a service level agreement, and/or an application requirement. Applications may include, without limitation, voice, streaming media, gaming, virtual reality, home automation, security, robotics, autonomous vehicles, such as cars and/or drones, machine-to-machine (M2M) communications, Internet of Things (IoT), email, messaging, web browsing and so on. For example, the first group of remote devices may include devices capable of high-fidelity streaming media, while the second group of remote devices may include less demanding, home automation systems. Alternatively, or in addition, the different types of remote devices 314 may be distinguished according to historical records, e.g., based on prior usage as may be evaluated according to one or more of data volumes, data types, data rates, applications, application categories, and the like. Alternatively, or in addition, at least some embodiments, the different groups of remote devices may be distinguished according to anticipated and/or predicted applications, data volumes, data types, data rates, and so on. It is envisioned that in at least some applications, the different types of remote devices 314 may be distinguished according to network performance as may be determined according to past performance, current network conditions and/or anticipated and/or predicted performance.

As may be beneficial, the host device 302 and/or the optical transmitter 304 may determine the first optical signal S1 and an association of the first optical signal with the first type of remote devices, e.g., remote devices 314a, 314n. For example, the first optical signal S1 may be based on one or more of a service, e.g., a subscribed network service, a class of network services, and/or third-party service, e.g., an over-the-top (OTT) service or class of OTT services, such as OTT media services. Alternatively, or in addition be associated with the first type of remote devices 314a, 314n may be determined according to one or more applications and/or categories of applications. In at least some embodiments, the host device 302 and/or the optical transmitter 304 may identify the first type of remote devices 314 and associate the first optical signal S1 with the first type of remote devices 314. Likewise, the host device 302 and/or the optical transmitter 304 may determine the second optical signal S2 and an association of the second optical signal with the second type of remote devices 314, e.g., remote device 314b, such that the first and second signals S1, S2 may support network services according to respective requirements, which may be the same, similar and/or different.

In at least some embodiments, the optical signal distribution device 307 includes a housing 330. The housing 330 includes an upstream housing terminal or port 310 coupled to one end of an upstream optical fiber segment 306, e.g., a feeder fiber, which may be coupled between the optical signal distribution device 307 and the optical transmitter 304. In at least some embodiments, the optical signal distribution device 307 has multiple downstream terminals or downstream ports 312a . . . 312b, generally 312. The downstream ports 312 are respectively coupled to first ends of a group of downstream optical fiber segments 316a . . . 316n, generally 316. The group of downstream optical fiber segments 216 have second ends that are respectively coupled to and/or otherwise in optical communication with the group of remote devices 314.

In at least some embodiments, the optical signal distribution device 307 includes at least one optical signal splitter 320. According to the illustrative example, the optical signal splitter 320 provide a 1×N power split in a downstream direction. An upstream terminal of the optical signal splitter 320 is in communication with an upstream housing port 310, while N output terminals of the optical signal splitter 320 are in communication with downstream housing ports 312a . . . 312n, generally 312.

In at least some embodiments, each of the N output terminals is coupled to a respective polarization device 322a . . . 322n. The polarization devices are configured to permit passage of one of at least two signals S1, S2 based on a preferred polarization P1, P2, while preventing passage of another one of at least two signals S1, S2. According to the illustrative example, first and n^{th} ones of the N output terminals are respectively coupled to first types of polarization device 322a, 322n, while a second one of the N output terminals is coupled to a second type of polarization device 322b. According to the illustrative embodiment, the first type of polarization devices 322a, 322n are configured to pass the first signal S1 having a first polarization P1, while blocking passage of the second signal S2 having a second polarization P2. Likewise, the second type of polarization devices 322b is configured to pass the second signal Ss having a second polarization P2, while blocking passage of the first signal S1 having a first polarization P1.

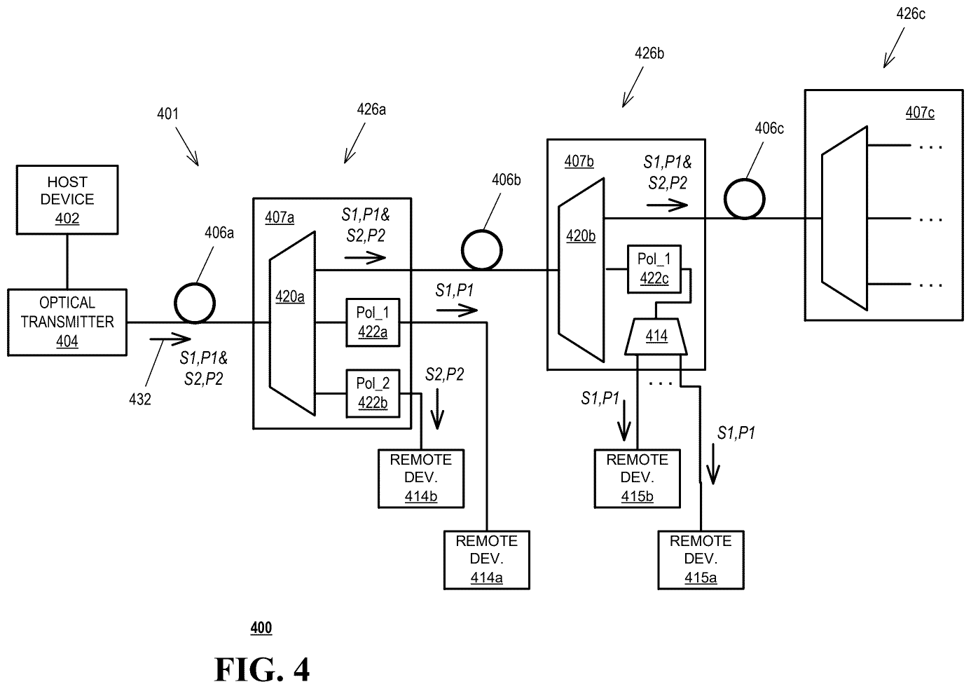

FIG. 4 is a block diagram illustrating an example, non-limiting embodiment of yet another polarization-sensitive optical access network 400 functioning within the communication network of FIG. 1 in accordance with various aspects described herein. The example polarization-sensitive optical access network 400 exchanges one or more optical signals over an optical fiber network 401. The example polarization-sensitive optical access network 400 also includes a first signal distribution device 407a configured to divide and/or otherwise split a downstream source signal 432 into a first group of optical breakout signals for distribution at a first location 426a and a first divided portion of the downstream source signal 432 directed to a second signal distribution device 407b configured to divide and/or otherwise split the divided portion of the downstream source signal 432 into a second breakout signals for distribution at a second location 426b and a second divided portion of the downstream source signal 432 directed to one or more other signal distribution devices, e.g., a third signal distribution device 407c at one or more subsequent locations 426c.

By way of example, the polarization-sensitive optical access network 400 includes at least one host device 402 coupled to at least one optical transmitter 404 via a first downstream or first fiber segment 406a, sometimes referred to as a feeder fiber. In at least some embodiments, the polarization-sensitive optical access network 400 includes an optical line terminal (OLT), configured to generate and/or otherwise provide, e.g., injection the downstream optical signal 432 into the optical fiber network 401. In at least some embodiments, the OLT may include one or more of the host device 402 and/or the optical transmitter 304. In at least some embodiments, the OLT, e.g., the host device 402 and/or the optical transmitter 404, may include one or more a central processing unit (CPU), passive optical network cards, a gateway router and a voice gateway uplink cards. The OLT, e.g., the host device and/or the optical transmitter 404 may be configured to modulate an optical carrier signal having characteristics well suited for broadband signal distribution over an extended distance and to a substantial number of remote devices, e.g., optical network terminals (ONT).

The first signal distribution device 407a may include any of the example signal distribution device configuration devices disclosed herein to selectively isolate a first and/or second optical signal S1, S2 according to its respective polarization P1, P2. Likewise, the second and any subsequent signal distribution device 407b, 407c may include any of the example signal distribution device configuration devices disclosed herein to selectively isolate a first and/or second optical signal S1, S2 according to its respective polarization P1, P2.

For example, the first optical signal distribution device 407a includes a first signal splitter 420a configured to split and/or otherwise divide the downstream optical signal 432 into three divided signals. A first divided signal is directed to a first polarization device 422a configured to pass the first signal S1 having a first polarization P1, while preventing passage of the second signal S2 having a second polarization P2. The first signal S1 can be directed to a first remote device 414a. Likewise, a second divided signal is directed to a second polarization device 422b configured to pass the second signal S2 having a second polarization P2, while preventing passage of the first signal S1 having a first polarization P1. The second signal S2 can be directed to a second remote device 414b. A third divided signal may be directed to the second optical signal distribution device 407b, without necessarily applying any polarization adjustments, such that a divided portion of the original downstream optical signal 432 is directed to the second optical distribution device 407b via a second fiber segment 406b.

According to the illustrative embodiment, the second optical signal distribution device 407b includes a second splitter 420b configured to split and/or otherwise divide the divided portion of the downstream optical signal 432 into three further divided signals. A first further divided signal is directed to a first polarization device 422c configured to pass the first signal S1 having a first polarization P1, while preventing passage of the second signal S2 having a second polarization P2. The first signal S1 can be further divided, e.g., according to the example 1×N divider 414 to obtain N divided first signals directed to a group of remote device 415a . . . 415b. A second divided signal may be directed to the third optical signal distribution device 407c, without necessarily applying any polarization adjustments, such that a further divided portion of the original downstream optical signal 432 is directed to the third optical distribution device 407c via a third fiber segment 406c. The process may continue in a like manner, e.g., until further division and/or polarization filtering results in unusable signals, e.g., a resulting optical signal level is too low for an intended application. In at least some embodiments, the signal distribution may be configured as described in U.S. patent application Ser. No. 18/781,006, entitled “Adjustable Optical Coupler,” filed on Jul. 23, 2024, and incorporated by reference herein in its entirety.

It is understood that any of the various example polarization-sensitive optical access networks 200, 300, 400 disclosed herein may be operated in a downstream direction, an upstream direction and/or a combination of downstream and upstream directions. It is understood further that any of the so-called optical signal splitter and/or power division devices of the downstream examples disclosed herein may function as signal combiners when operated in an upstream configuration.

In at least some embodiments, one or more of the optical signal distribution devices 207, 307, 407 may include configurable devices. For example, the optical signal distribution devices 207, 307, 407 may include chassis and/or housings 230, 330 within which one or more of the various components, e.g., the optical signal splitters 220, 320, 420, power dividers, combiners and/or polarization devices 222, 322, 422 may be configurable. Configurable includes without limitation, a modular configuration in which one or more of the various devices may be selected, introduced into a chassis or housing and interconnected so as to obtain a desired signal distribution and/or routing. For example, an optical signal splitter 220, 320, 420 may be selected and introduced into the chassis or housing 230, 330 based on a required number of divided signals, e.g., a value of N and/or M. Alternatively, or in addition, the polarization devices 222, 322, 422 may be selected and introduced into the chassis or housing 230, 330 based on a signal routing requirement, e.g., a map as to which of the chassis downstream ports 212, 213, 312, 412 are associated with which signal S1, S2 according to respective polarizations P1, P2.

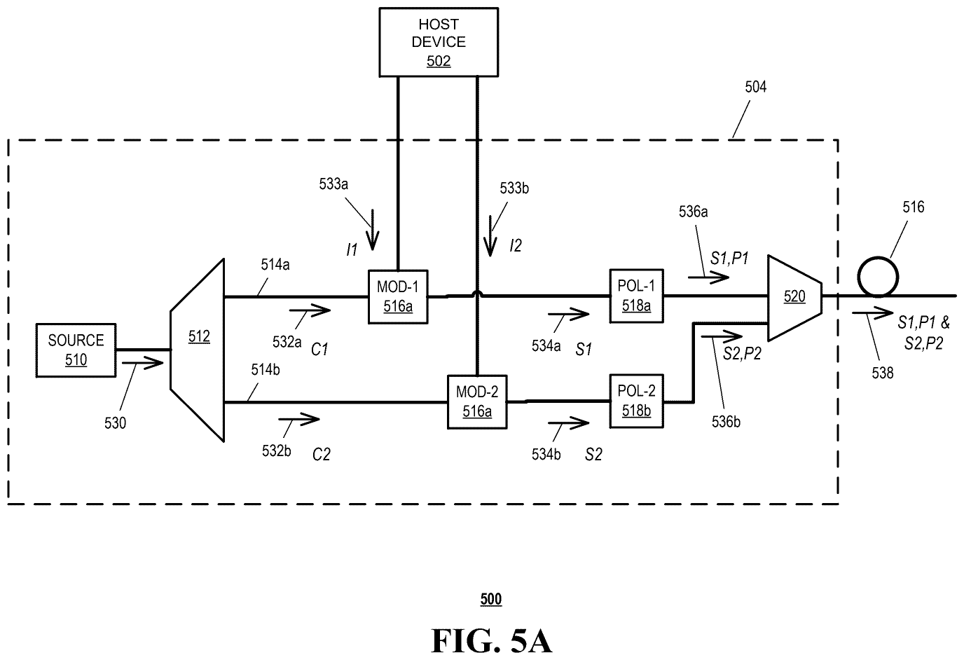

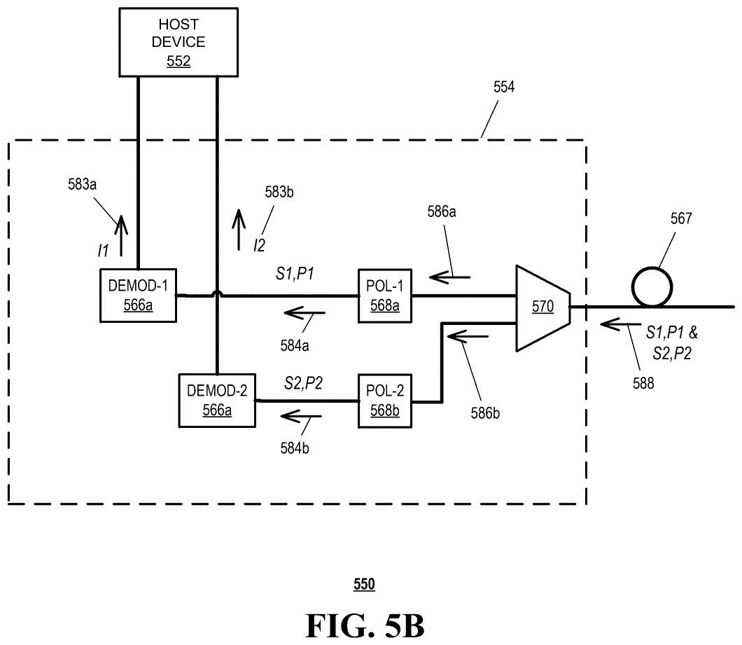

FIG. 5A is a block diagram illustrating an example, non-limiting embodiment of an optical terminal 500 functioning within the communication network 100 of FIG. 1 in accordance with various aspects described herein. The optical terminal 500 includes at least one host device 502 in communication with an optical transmitter 504. Among other functions, the host device 502 provides information content to be transported by a communication network. According to the illustrative embodiment, the host device 502 provides two information signals 533a, 533b, generally 533, and labelled to as I1 and I2. It is understood that in at least some embodiments, the host device 502 may be configured to provide one information channel and/or more than two information channels. Alternatively, or in addition, two or more host devices 502 may be in communication with the optical transmitter 504, with different information signals 533 being provided by the different host devices 502. In at least some embodiments, the host device 502 may provide additional information, such as control signaling as may be used to facilitate routing of one or more optical signals S1, S2 to intended destinations.

According to the illustrative embodiment, the optical transmitter 504 includes a signal source 510 providing a carrier wave signal 530 suitable for accepting modulation to convey information via one or more signals S1, S2. For example, the signal source 510 may include an optical source, such as a laser. In at least some embodiments, the optical source is a semiconductor device, such as an LED or laser diode. In at least some embodiments, the carrier wave is selected to provide favorable performance characteristics when transported via a communication network, such as any of the example optical fiber networks 201, 301, 401 of FIGS. 2-4, disclosed herein. Performance characteristics may include, without limitation, operating wavelength, coherence, power level.

In at least some embodiments, the optical transmitter 504 includes a signal splitter 512 having an upstream terminal in communication with the signal source 510. The signal splitter 512 can configured to provide a power division to the carrier wave signal 530 received at the upstream terminal. Divided signal portions may be distributed via downstream terminals of the signal splitter 512. According to the illustrative embodiment, the signal splitter 512 splits the received carrier wave signal 530 into two divided carrier wave signals 532a, 532c, generally 532, and labelled as C1 and C2. It is understood that a signal splitting ratio and/or power division ratio may be determined based on a number of different signals to be injected into a feeder fiber 516 for distribution via an optical fiber network 201, 301, 401. Accordingly, the signal splitter 512 may provide a different number, i.e., N, divided carrier wave signals according to a design requirement. Although the example divided power ratio is equal, i.e., Pin/N, it is envisioned that in at least some embodiments, the signal splitter 512 may be configured to provide other power ratios as may be determined according to supported services, numbers and/or types of remote devices, and/or supported services and/or applications.

In at least some embodiments, the optical transmitter 504 includes a first modulator 516a and a first polarization device, e.g., a first polarization selector 518a and/or filter. The first modulator and the first polarization selector 518a are coupled to a first signal path 514a carrying a first divided carrier wave signal 532a. The first modulator 516a is in communication with the host device 502, receiving the first information signal 533a. The first modulator 516a can be adapted to modulate the first divided carrier wave signal 532a according to the first information signal 533a to impress information content of the first information signal 533a onto the first divided carrier wave signal 532a to obtain a first modulated signal 534a. The first polarization selector 518a can be configured to polarize the first divided carrier wave signal 534a according to a first polarization P1 to obtain a first polarized, divided carrier wave signal 536a.

Likewise, the optical transmitter 504 includes a second modulator 516b and a second polarization device, e.g., a second polarization selector 518b and/or filter. The second modulator 516a and the second polarization selector 518b are coupled to a second signal path 514b carrying a second divided carrier wave signal 532b. The second modulator 516b is also in communication with the host device 502, receiving the second information signal 533b. The second modulator 516b can be adapted to modulate the second divided carrier wave signal 532b according to the second information signal 533b to impress information content of the second information signal 533b onto the second divided carrier wave signal 532b to obtain a second modulated signal 534b. The second polarization selector 518b can be configured to polarize the second modulated signal 534b according to a second polarization P2 to obtain a second polarized, divided carrier wave signal 536b.

The optical transmitter 504 can include a signal combiner 520 having a first input terminal coupled to the first signal path 514a and a second input terminal coupled to the second signal path 514b. The signal combiner 520 is configured to combine the first polarized, divided carrier wave signal 532a with the second polarized, divided carrier wave signal 532b to obtain a dual polarized combined signal 538 at an output terminal. The output terminal can be coupled to a feeder fiber 517, such that the dual polarized combined signal 538 can be launched into an optical fiber network 201, 301, 401 via the feeder fiber 517.

In at least some embodiments, the first modulator 516a is located between the signal splitter 512 and the first polarization device 518a and the second modulator 516b is located between the signal splitter 512 and the second polarization device 518a. This configuration can be utilized to modulate the first and second portions of the divided carrier wave signal 532a, 532b prior to selecting the first and second polarizations P1, P2, i.e., modulating unpolarized optical carrier segments. In at least some embodiments, the first polarization device 518a is located between the signal splitter 512 and the first modulator 516a and second polarization device 518b is located between the signal splitter 512 and the second modulator 516b. This configuration can be utilized to modulate first and second portions of the divided carrier wave signal 532a, 532b that have been polarized according to the first and second polarizations P1, P1, prior to modulation, i.e., modulating optical carrier segments.

Without limitation, the first and/or second modulators 516a, 516b may be configured to provide a modulation, such as an amplitude modulation, a frequency modulation and/or a phase modulation. Example modulation types include, without limitation, ASK, FSK, PSK, BPSK, QPSK, QAM. In some embodiments, the first and second modulators are configured to apply the same and/or similar type of modulation, e.g., both applying QPSK and/or QAM. Alternatively, or in addition, the first and second modulators may be configured to apply different types of modulation, e.g., QAM 64 on one polarization P1 and QAM 16 on another polarization P2.

FIG. 5B is a block diagram illustrating an example, non-limiting embodiment of another optical terminal functioning within the communication network of FIG. 1 in accordance with various aspects described herein. The optical terminal 550 includes at least one host device 502 in communication with an optical receiver 554. According to the illustrative embodiment, the optical receiver 554 includes a signal splitter 570 having a downstream terminal coupled to a feeder fiber 567. The signal splitter 570 receives an upstream modulated optical signal 588 including multiple polarized signal components, e.g., a first signal component S1 provided according to a first polarization P1 and a second signal component S2 provided according to a second polarization P2. The signal splitter 570 splits the received upstream modulated optical signal 588 and splits it into a number of upstream signal components. In at least some embodiments, the number of upstream signal components corresponds to the number of different polarizations. According to the illustrative example, the signal splitter 570 provide a 1×2 optical power division to obtain a first divided upstream signal component 586a at a first divided signal terminal and a second divided upstream signal component 586b provided at a second divided signal terminal.

In at least some embodiments, the optical receiver 554 includes a first demodulator 566a in communication with the first divided signal terminal of the signal splitter 570. The optical receiver further includes a first polarization device 548a in communication between the first divided signal terminal of the signal splitter 570 and the first demodulator 566a. The first polarization device 584a isolates a first polarized signal portion 584a of the first divided upstream signal component 586a. The first demodulator 566a is configured to detect and/or otherwise demodulate the first polarized signal portion S1, P1 to obtain a first information content 583a, i.e., I1, which can be provided to the host device 552. Likewise, the optical receiver 554 includes a second demodulator 566b in communication with the second divided signal terminal of the signal splitter 570. The optical receiver further includes a second polarization device 548b in communication between the second divided signal terminal of the signal splitter 570 and the second demodulator 566b. The second polarization device 58b isolates a second polarized signal portion 584b of the second divided upstream signal component 586b. The second demodulator 566b is configured to detect and/or otherwise demodulate the second polarized signal portion S2, P2 to obtain a second information content 583b, i.e., I2, which can be provided to the host device 552.

Without limitation, the first and/or second demodulators 566a, 566b may be configured to demodulate according to, at least one of an amplitude modulation, a frequency modulation and/or a phase modulation. Example modulation types include, without limitation, ASK, FSK, PSK, BPSK, QPSK, QAM. In some embodiments, the first and second demodulators 566a, 566b, generally 566, are configured to apply the same and/or similar type of demodulation, e.g., both applying QPSK and/or QAM. Alternatively, or in addition, the first and second demodulators 566 may be configured to apply different types of demodulation, e.g., QAM 64 on one polarization P1 and QAM 16 on another polarization P2.

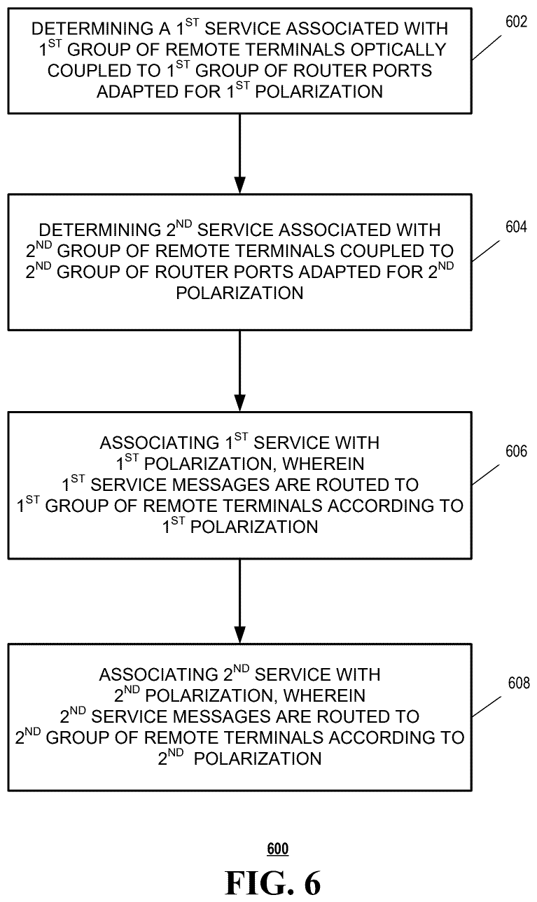

FIG. 6 depicts an illustrative embodiment of a polarization-sensitive optical signal distribution process 600 in accordance with various aspects described herein. The example process 600 includes determining, at 602, a first service associated with a first group of remote terminals optically coupled to a first group of router ports adapted for a first polarization. The example process 600 further includes determining second service associated with a second group of remote terminals coupled to a second group of router ports adapted for a second polarization. Further according to the example process 600, a first service is associated, at 606, with a first polarization, wherein first service messages are routed to a first group of remote terminals according to the first polarization. The example process 600 further includes associating a second service with the second polarization, wherein second service messages are routed to a second group of remote terminals according to the second polarization.

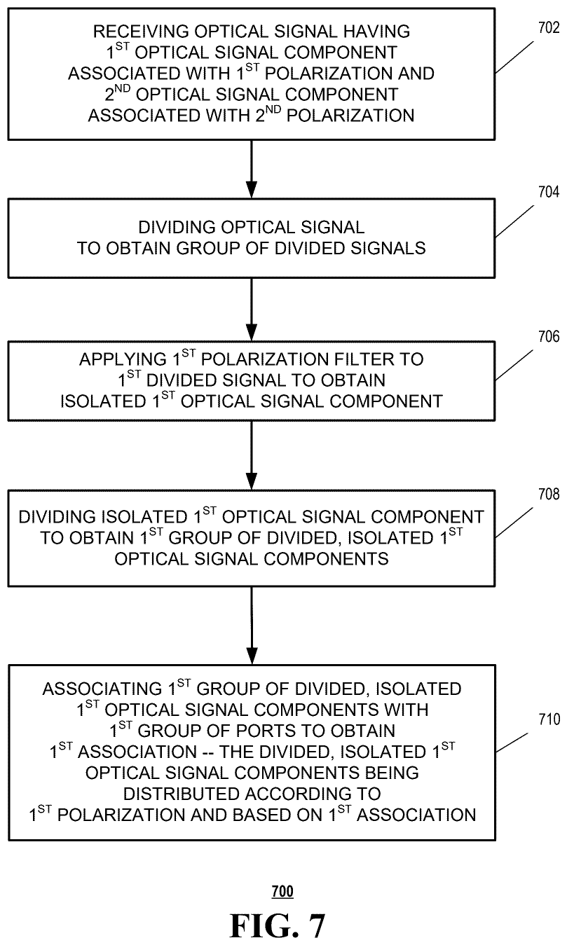

FIG. 7 depicts an illustrative embodiment of another polarization-sensitive optical signal distribution process 700 in accordance with various aspects described herein. The example polarization-sensitive optical signal distribution process 700 includes receiving, at 702, an optical signal having a first optical signal component associated with a first polarization and a second optical signal component associated with a second polarization. The optical signal is divided, at 704, to obtain group of divided signals and a first polarization filter is applied, at 706, to a first divided signal to obtain an isolated first optical signal component. According to the example process 700, the isolated first optical signal component is divided to obtain a first group of divided, isolated first optical signal components. The first group of divided, isolated first optical signal components are associated, at 710, with a first group of ports to obtain first association. The divided, isolated first optical signal components are distributed according to the first polarization and based on the first association.

While for purposes of simplicity of explanation, the respective processes are shown and described as a series of blocks in FIGS. 6 and 7 it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

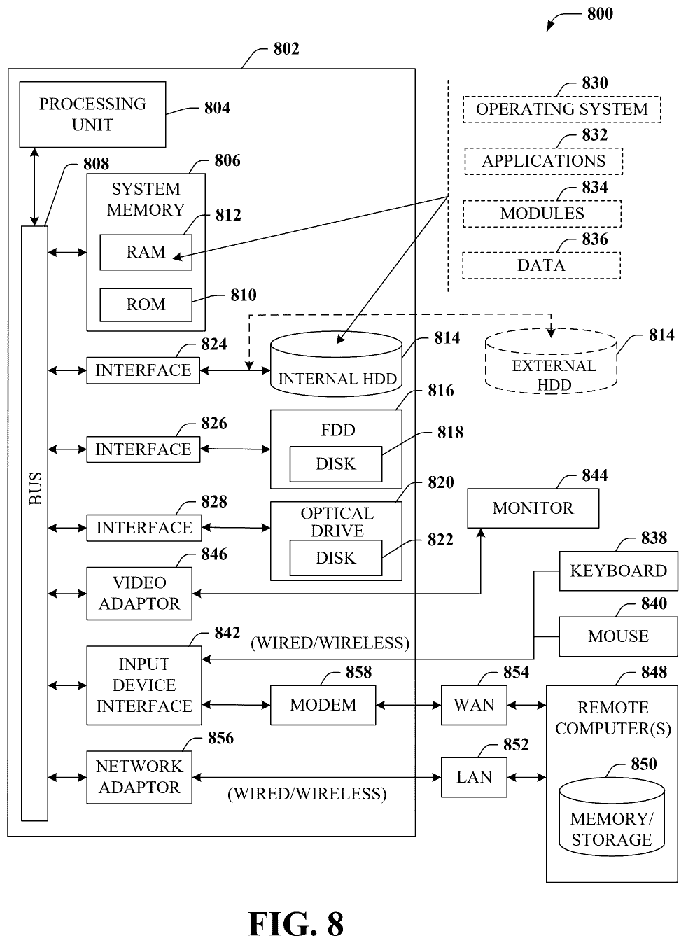

With reference again to FIG. 8, the example environment 800 can comprise a computer 802, the computer 802 comprising a processing unit 804, a system memory 806 and a system bus 808. The system bus 808 couples system components including, but not limited to, the system memory 806 to the processing unit 804. The processing unit 804 can be any of various commercially available processors. Dual microprocessors and other multiprocessor architectures can also be employed as the processing unit 804. It is envisioned that the computer 802 may be configured according to any of the example control devices disclosed herein, such as an amplifier gain controller, an optical signal gain feedback controller, a controller adapted to implement one or more rules and/or policies as may be utilized in operation of any of the example systems and/or devices disclosed herein, such as determining signal splitting configurations, e.g., ratios of optical signal splitters and/or combiners, numbers of optical signal splitters and/or combiners, staging, whether single stage and/or multi-stage of optical signal division, determination of and/or implementation of optical amplifier gain values, and so on.

The system bus 808 can be any of several types of bus structure that can further interconnect to a memory bus (with or without a memory controller), a peripheral bus, and a local bus using any of a variety of commercially available bus architectures. The system memory 806 comprises ROM 810 and RAM 812. A basic input/output system (BIOS) can be stored in a non-volatile memory such as ROM, erasable programmable read only memory (EPROM), EEPROM, which BIOS contains the basic routines that help to transfer information between elements within the computer 802, such as during startup. The RAM 812 can also comprise a high-speed RAM such as static RAM for caching data.

The computer 802 further comprises an internal hard disk drive (HDD) 814 (e.g., EIDE, SATA), which internal HDD 814 can also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high-capacity optical media such as the DVD). The HDD 814, magnetic FDD 816 and optical disk drive 820 can be connected to the system bus 808 by a hard disk drive interface 824, a magnetic disk drive interface 826 and an optical drive interface 828, respectively. The hard disk drive interface 824 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 802, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 812, comprising an operating system 830, one or more application programs 832, other program modules 834 and program data 836. All or portions of the operating system, applications, modules, and/or data can also be cached in the RAM 812. The systems and methods described herein can be implemented utilizing various commercially available operating systems or combinations of operating systems.

A user can enter commands and information into the computer 802 through one or more wired/wireless input devices, e.g., a keyboard 838 and a pointing device, such as a mouse 840. Other input devices (not shown) can comprise a microphone, an infrared (IR) remote control, a joystick, a game pad, a stylus pen, touch screen or the like. These and other input devices are often connected to the processing unit 804 through an input device interface 842 that can be coupled to the system bus 808, but can be connected by other interfaces, such as a parallel port, an IEEE 1394 serial port, a game port, a universal serial bus (USB) port, an IR interface, etc.

A monitor 844 or other type of display device can be also connected to the system bus 808 via an interface, such as a video adapter 846. It will also be appreciated that in alternative embodiments, a monitor 844 can also be any display device (e.g., another computer having a display, a smart phone, a tablet computer, etc.) for receiving display information associated with computer 802 via any communication means, including via the Internet and cloud-based networks. In addition to the monitor 844, a computer typically comprises other peripheral output devices (not shown), such as speakers, printers, etc.

The computer 802 can operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically comprises many or all of the elements described relative to the computer 802, although, for purposes of brevity, only a remote memory/storage device 850 is illustrated. The logical connections depicted comprise wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which can connect to a global communications network, e.g., the Internet.

When used in a LAN networking environment, the computer 802 can be connected to the LAN 852 through a wired and/or wireless communication network interface or adapter 856. The adapter 856 can facilitate wired or wireless communication to the LAN 852, which can also comprise a wireless AP disposed thereon for communicating with the adapter 856.

When used in a WAN networking environment, the computer 802 can comprise a modem 858 or can be connected to a communications server on the WAN 854 or has other means for establishing communications over the WAN 854, such as by way of the Internet. The modem 858, which can be internal or external and a wired or wireless device, can be connected to the system bus 808 via the input device interface 842. In a networked environment, program modules depicted relative to the computer 802 or portions thereof, can be stored in the remote memory/storage device 850. It will be appreciated that the network connections shown are example and other means of establishing a communications link between the computers can be used.

The computer 802 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches, and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature, or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. An optical signal distribution device, comprising:
a housing comprising:
a source port configured to receive an optical signal comprising a first optical signal component associated with a first polarization and a second optical signal component associated with a second polarization;
a plurality of destination ports;
a first optical signal divider comprising an undivided signal terminal optically coupled to the source port and a plurality of divided signal terminals, wherein the first optical signal divider is configured to divide the optical signal to obtain a plurality of divided signals presented at the plurality of divided signal terminals; and
a first polarization discriminator optically coupled between a first one of the plurality of divided signal terminals and a at least one of a first group of destination ports of the plurality of destination ports, wherein the first polarization discriminator is configured to isolate the first optical signal component associated with the first polarization to obtain an isolated first optical signal component.

2. The optical signal distribution device of claim 1, wherein the housing further comprises:
a second optical signal divider comprising an undivided signal terminal optically coupled between the first polarization discriminator and a first group of the plurality of destination ports, wherein the second optical signal divider is configured to divide the isolated first optical signal component to obtain a plurality of divided, isolated first optical signal components, wherein the first optical signal component is routed according to the first group of the plurality of destination ports according to the first polarization.

3. The optical signal distribution device of claim 1, wherein the housing further comprises:
a second polarization discriminator optically coupled between a second one of the plurality of divided signal terminals and a at least one of a second group of destination ports of the plurality of destination ports, wherein the second polarization discriminator is configured to isolate the second optical signal component associated with the second polarization to obtain an isolated second optical signal component, wherein the second optical signal component is routed according to the second group of the plurality of destination ports according to the second polarization.

4. The optical signal distribution device of claim 3, wherein the first polarization and the second polarization are orthogonal polarizations.

5. The optical signal distribution device of claim 3, wherein the first polarization and the second polarizations comprise at least one of a linear polarization, a circular polarization, or an elliptical polarization.

6. The optical signal distribution device of claim 3, wherein the housing further comprises:
a second optical signal divider comprising an undivided signal terminal optically coupled between the first polarization discriminator and a first group of the plurality of destination ports, wherein the second optical signal divider is configured to divide the isolated first optical signal component to obtain a plurality of divided, isolated first optical signal components, wherein the first optical signal component is routed according to the first group of the plurality of destination ports according to the first polarization; and
a third optical signal divider comprising an undivided signal terminal optically coupled between the second polarization discriminator and a second group of the plurality of destination ports, wherein the third optical signal divider is configured to divide the isolated second optical signal component to obtain a plurality of divided, isolated second optical signal components, wherein the second optical signal component is routed according to the second group of the plurality of destination ports according to the second polarization.

7. The optical signal distribution device of claim 1, wherein the first optical signal divider comprises an optical power divider.

8. The optical signal distribution device of claim 7, wherein the optical power divider is configured to divide the optical signal evenly to obtain a plurality of substantially equivalent divided signals presented at the plurality of divided signal terminals.

9. The optical signal distribution device of claim 1, wherein the first optical signal component is modulated according to a first modulation type and the second optical signal component is modulated according to a second modulation type.

10. The optical signal distribution device of claim 9, wherein the first and second modulation types differ.

11. The optical signal distribution device of claim 1, wherein the first optical signal component bears first information associated with a first service and the second optical signal component bears second information associated with a second service.

12. The optical signal distribution device of claim 11, wherein the first service is directed to a first group of remote devices via a first group of the plurality of destination ports based on the first polarization and according to a first service requirement, and wherein the second service is directed to a second group of remote devices via a second group of the plurality of destination ports based on the second polarization and according to a second service requirement.

13. An optical signal distribution method, comprising:
receiving an optical signal comprising a first optical signal component associated with a first polarization and a second optical signal component associated with a second polarization;
dividing the optical signal to obtain a plurality of divided signals;
applying a first polarization filter to a first one of the plurality of divided signals to obtain an isolated first optical signal component;
dividing the isolated first optical signal component to obtain a first plurality of divided, isolated first optical signal components; and
associating the first plurality of divided, isolated first optical signal components with a first plurality of ports to obtain a first association, wherein the divided, isolated first optical signal components are distributed according to the first polarization and based on the first association.

14. The optical signal distribution method of claim 13, further comprising:
applying a second polarization filter to a second one of the plurality of divided signals to obtain an isolated second optical signal component;
dividing the isolated second optical signal component to obtain a second plurality of divided, isolated second optical signal components; and
associating the second plurality of divided, isolated second optical signal components with a second plurality of ports to obtain a second association, wherein the divided, isolated second optical signal components are distributed according to the second polarization and based on the second association.

15. The optical signal distribution method of claim 14, wherein the first optical signal component is modulated according to a first modulation type and the second optical signal component is modulated according to a second modulation type.

16. The optical signal distribution method of claim 15, wherein the first and second modulation types differ.

17. The optical signal distribution method of claim 13, wherein the first optical signal component bears first information associated with a first service and the second optical signal component bears second information associated with a second service.

18. The optical signal distribution method of claim 17, wherein the first service is directed to a first group of remote devices via the first plurality of ports based on the first polarization and according to a first service requirement, and wherein the second service is directed to a second group of remote devices via a second group of ports based on the second polarization and according to a second service requirement.

19. The optical signal distribution method of claim 13, wherein the dividing the isolated first optical signal component further comprises equally dividing the optical signal to obtain a first plurality of substantially equally divided, isolated first optical signal components.

20. A non-transitory machine-readable medium, comprising executable instructions that, when executed by a processing system including a processor, facilitate performance of operations, the operations comprising:
determining a first service associated with a first group of remote terminals optically coupled to a first group of router ports adapted for a first polarization;
determining a second service associated with a second group of remote terminals coupled to a second group of router ports adapted for a second polarization;
associating the first service with the first polarization, wherein first service messages are routed to the first group of remote terminals according to the first polarization; and
associating the second service with the second polarization, wherein second service messages are routed to the second group of remote terminals according to the second polarization.
